(19) United States
(12) Patent Application Publication
(10) Pub. No.: US 2008/0282346 A1
(43) Pub. Date: Nov. 13, 2008

(54) Data Type Management Unit

(75) Inventors: Kevin S. Gudeth, Algonquin, IL (US); Eric Ridvan Uner, Carpentersville, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/746,703

(22) Filed: May 10, 2007

(51) Int. Cl. G06F 11/00

(52) U.S. Cl. 726/22

(57) ABSTRACT

A data type management unit. The data type management unit is configured to include a rules module which includes at least one identification standard paired with an associated code type, an interface module configured to receive a code signal, and an analysis module coupled to the interface module and to the rules module. Each identification standard includes a comparison rule paired with an associated rejection criteria; the comparison rule of each identification standard includes at least one code pattern representative of the associated code type; and the rejection criteria of each identification standard includes at least one rejection rule. The analysis module is configured to compare the received code signal to each code pattern in each identification standard and to recognize if one or more of the comparison results violates one or more of the rejection rules.

### BACKGROUND

Modern network coupled components, such as computers and other devices, are vulnerable to intrusion or attack from clandestine sources which are referred to herein as attackers. Attackers find and use vulnerabilities in the software of embedded systems to execute their own code on the attacked system. Data interfaces of the system are used to deposit illicit code in a buffer somewhere in the system. Vulnerabilities in the system software are used to transfer control of the code to inside the buffer. Buffer overflows or smashing the stack are often used to direct execution of some system code to some of the illicit code that has been surreptitiously placed in the system. Using such methods, data interfaces can be used to deliver code instead of or along with data intended for the interface, which will then allow an attacker to later execute the code by exploiting vulnerabilities in the software.

Methods, systems, and software programs have been proposed for monitoring user behavior for server applications in a computer network. Such items can monitor communication data between a server application and a client and can include identifying a variety of predetermined activities, as well as generating a threat score associated with the predetermined activities by comparing them with a security threshold criteria.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding elements.

FIG. 1 is a block diagram of a data processing system as described in various representative embodiments.

FIG. 2 is a block diagram of the data type management unit of FIG. 1.

FIG. 3 is a block diagram of one of the identification standards of FIG. 2.

FIG. 4 is a flow diagram of a method for determining whether or not a rejection criteria is violated for a received code signal as described in various representative embodiments.

FIG. 5 is a flow diagram of the analysis block of the method of FIG. 4.

FIG. 6 is a block diagram of another data processing system as described in various representative embodiments.

FIG. 7 is a block diagram of the data type management unit of FIG. 6.

FIG. 8 is a flow diagram of another method for determining whether or not a rejection criteria is violated for a received code signal as described in various representative embodiments.

FIG. 9 is a flow diagram of the analysis performed in block of the method of FIG. 8.

FIG. 10 is a flow diagram of the determination block of FIG. 9.

FIG. 11 is a flow diagram of the analysis block of FIG. 9.

### DETAILED DESCRIPTION

As shown in the drawings for purposes of illustration, novel techniques are disclosed herein for preventing an intrusion or attack from clandestine sources. Data type management units and methods are disclosed for preventing attackers from sending code through data interfaces. The data type management unit can be programmed to prevent transmission of signals that do not meet certain criteria through a data interface and optionally to provide notification of such an attempt. Alternatively, the data type management unit can be programmed to monitor, but not prevent, the transmission of signals that do not meet certain criteria through the data interface and to provide notification of such transmissions. The techniques disclosed herein can be used to control the flow of code signals into and out of devices and systems such as computer memories, a computer's central processing unit, and the like. Previous techniques for preventing such attacks have monitored user behavior for server applications in computer networks. The identification of a variety of predetermined activities on the network, the generation of a threat score associated with these activities, and then the comparison of that threat score with predetermined security threshold criteria have been proposed for preventing such intrusions.

In the following detailed description and in the several figures of the drawings, like elements are identified with like reference numerals.

In a representative embodiment, the data type management unit controls the flow of code signals entering and/or exiting a communication channel. The data type management unit can be programmed to recognize one or more specific data types in a signal and, if the signal does not meet certain criteria, to prevent the signal from passing through a data interface. If the signal does not meet that criteria, notification of such can be provided by the data type management unit. As an example, a processor could be so notified by the data type management unit.

In another representative embodiment, the data type management unit monitors signals propagating in a communication channel and/or through a data interface. The data type management unit can be programmed to recognize one or more specific data types in a signal and, if the signal does not meet certain criteria, to provide notification of that fact. As an example, a processor could be so notified by the data type management unit.

As an example, a data type management unit could be very useful with an interface that expects only string input. The data type management unit could be programmed to prevent signals flowing through that data interface that are not text. If a signal is found to contain code that is other than text, it could block that signal and provide notification to another device which could be, for example, a processor. An attacker would then not be able to send code instructions in a signal through such an interface that the attacker could later execute.

In another example, the data type management unit could be programmed to recognize and pass binary code through a data interface. For this example, the binary data type to be allowed to pass through the data interface could be binary data other than code instructions. In such case, an additional requirement can be placed on signals associated with that data interface. Since it is possible for binary data to look like code instructions, this additional requirement could specify how much of the signal can appear to be code instructions. As an example, this additional requirement could be a maximum number of code instructions or a ratio of a measure of the code instructions to a measure of the total signal. The data type management unit would monitor the data interface looking for code instructions. If the data type management unit finds a specified percentage or a specified number of instructions, an alert can be sent to another module which could be, for example, a processor. By such means, an attacker could be prevented from sending code instructions that the attacker could execute later through the data interface.

To prevent an attacker from changing the programming of the data type management unit to allow code to be sent to data interfaces, the data type management unit can be prevented from being reprogrammed until a power reset of the system of which it is a part. Representative embodiments of data type management units having capabilities as disclosed herein could be used to prevent attacks on various systems and devices which could be cell phones, cable modems, cable set-top boxes, computers, and the like.

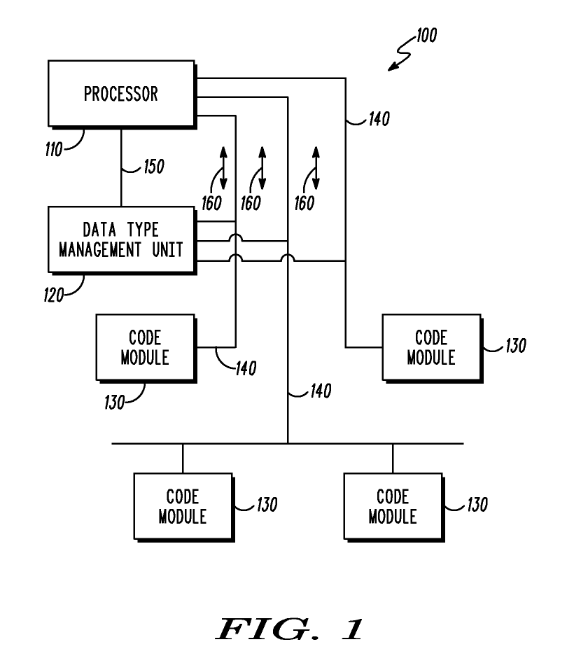

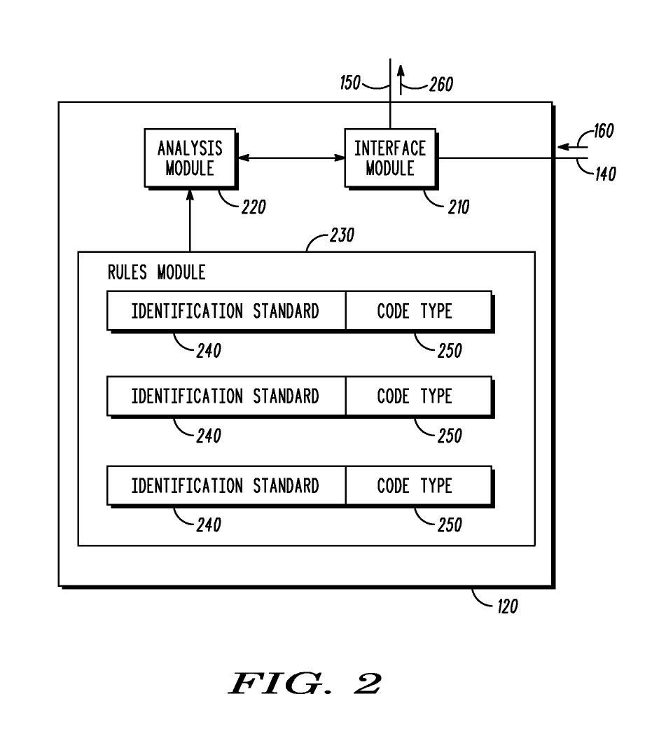

FIG. 1 is a block diagram of a data processing system 100 as described in various representative embodiments. FIG. 1 shows a data type management unit 120 in a monitor interface embodiment. In FIG. 1, a processor 110, which may be referred to more generally as a control module 110 herein, and the data type management unit 120 receive code signals 160 from code modules 130 on code transmission channels 140. The processor 110 also transmits code signals 160 to the code modules 130 on the code transmission channels 140. The data type management unit 120 also receives the code signals 160 transmitted by the processor 110 but does not transmit code signals 160 on the code transmission channels 140. Thus, in the embodiment of FIG. 1, the data type management unit 120 monitors, but does not directly interfere with, the signals transmitted on the code transmission channels 140. The data type management unit 120 communicates with the processor 110 via a processor transmission channel 150. The code transmission channel 140 may also be referred to herein as first transmission channel 140, and the processor transmission channel may also be referred to herein as second transmission channel 150. In this representative embodiment, the data type management unit 120 is programmed to inform the processor 110 whenever the code signals 160 being transmitted on the code transmission channels 140 violate the criteria of the rules module 230 (see FIG. 2).

FIG. 2 is a block diagram of the data type management unit 120 of FIG. 1. For implementations of the representative embodiment of FIG. 2, the data type management unit 120 would not typically interface with a memory management unit. In FIG. 2, the data type management unit 120 comprises an interface module 210, an analysis module 220, and a rules module 230. The rules module 230 comprises an identification standard 240 associated with a code type 250 for each code type 250 that the data type management unit 120 needs to be able to recognize. The interface module 210 is coupled to the analysis module 220, the first transmission channel 140 and the second transmission channel 150. FIG. 1 shows the first transmission channel 140 as coupling the data type management unit 120 to code modules 130 and second transmission channel 150 coupling the data type management unit 120 to the control module 110. However, both the first transmission channel 140 and the second transmission channel 150 could couple the data type management unit 120 to more generally configured external modules 110,130 either of which could be a code module 130, a control module 110, a processor 110, a central processing unit 110, or other appropriately configured modules, as for example a computer memory. The first transmission channel 140 and the second transmission channel 150 could be computer buses, data channels, or the like.

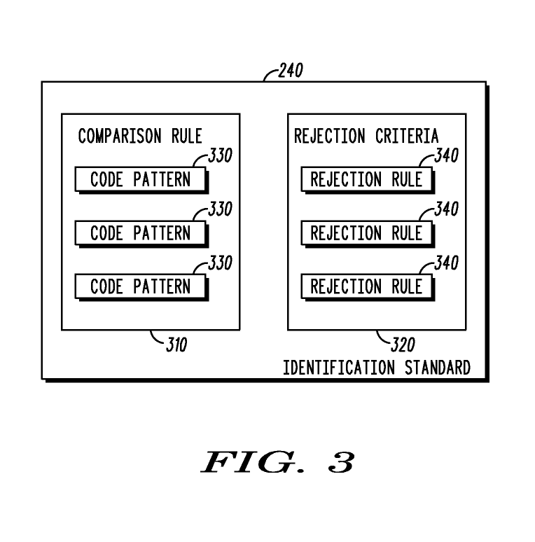

FIG. 3 is a block diagram of one of the identification standards 240 of FIG. 2. FIG. 3 shows the elements of a representative embodiment of one of the identification standards 240. The identification standard 240 comprises a comparison rule 310 and a rejection criteria 320. The comparison rule 310 comprises one or more code patterns 330. The code patterns 330 are patterns representative of the associated code type 250. A code signal 160 of a given code type 250 would be expected to contain at least one of the code patterns 330 for the identification standard 240 associated with that code type 250. The rejection criteria 320 comprises one or more rejection rules 340 of which each, if violated, is the basis for informing the control module 110 of such violation for the code signal 160.

In operation, the interface module 210 receives one or more code signals 160 on at least one code transmission channel 140 from at least one code module 130. The interface module 210 appropriately modifies the received code signals 160 which may include stripping and/or adding various code sequences that encapsulate the coded information in the code signal 160. The modified code signal 160 may then be transferred to the analysis module 220 or may remain in the interface module 210 for subsequent analysis. The analysis module 220 retrieves identification standards 240 and the code type 250 associated with each identification standard 240 from the rules module 230. Each identification standard 240 retrieved comprises a comparison rule 310 and a rejection criteria 320, each comparison rule 310 comprises at least one code pattern 330 representative of the associated code type 250. Each of the rejection criteria 320 comprises one or more rejection rules 340 of which each, if violated, is the basis for informing the control module 110 of such violation for the code signal 160. For each code signal 160 transferred to the analysis module 220, the analysis module 220 separately compares each identification standard 240 using its associated code patterns 330 against the transferred code signal 160 and evaluates the results of each comparison. If the comparison violates any one of the rejection rules 340 of its associated rejection criteria 320 for any one of the comparisons, the analysis module 220 notifies the control module 110 of such violation via a notification signal 260 on the processor transmission channel 150.

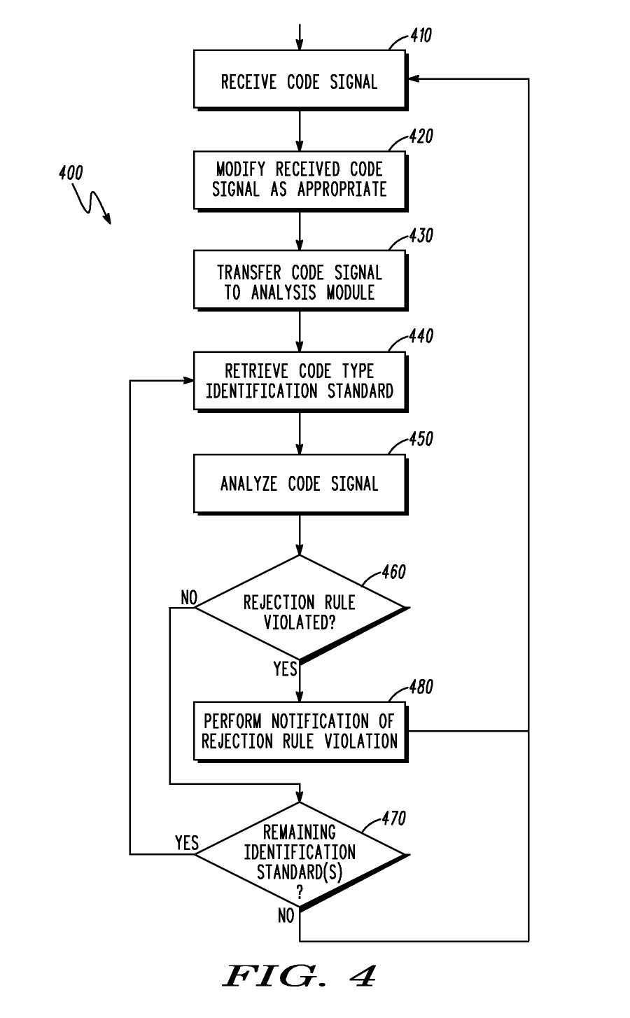

FIG. 4 is a flow diagram of a method 400 for determining whether or not a rejection criteria 320 is violated for a received code signal 160 as described in various representative embodiments. FIG. 4 is applicable to the use of a data type management unit 120 in a monitor interface implementation. In block 410, a code signal 160 is received by the interface module 210 of the data type management unit 120. Block 410 then transfers control to block 420.

In block 420, the interface module 210 appropriately modifies the received code signals 160 as necessary which may include stripping and/or adding various code sequences that encapsulate the coded information in the code signal 160. Block 420 then transfers control to block 430.

In block 430, the modified code signal 160 may optionally be transferred to the analysis module 220. Block 430 then transfers control to block 440.

In block 440, one of the code type 250 identification standards 240 not previously received for the code signal 160 is retrieved from the rules module 230. Block 440 then transfers control to block 450.

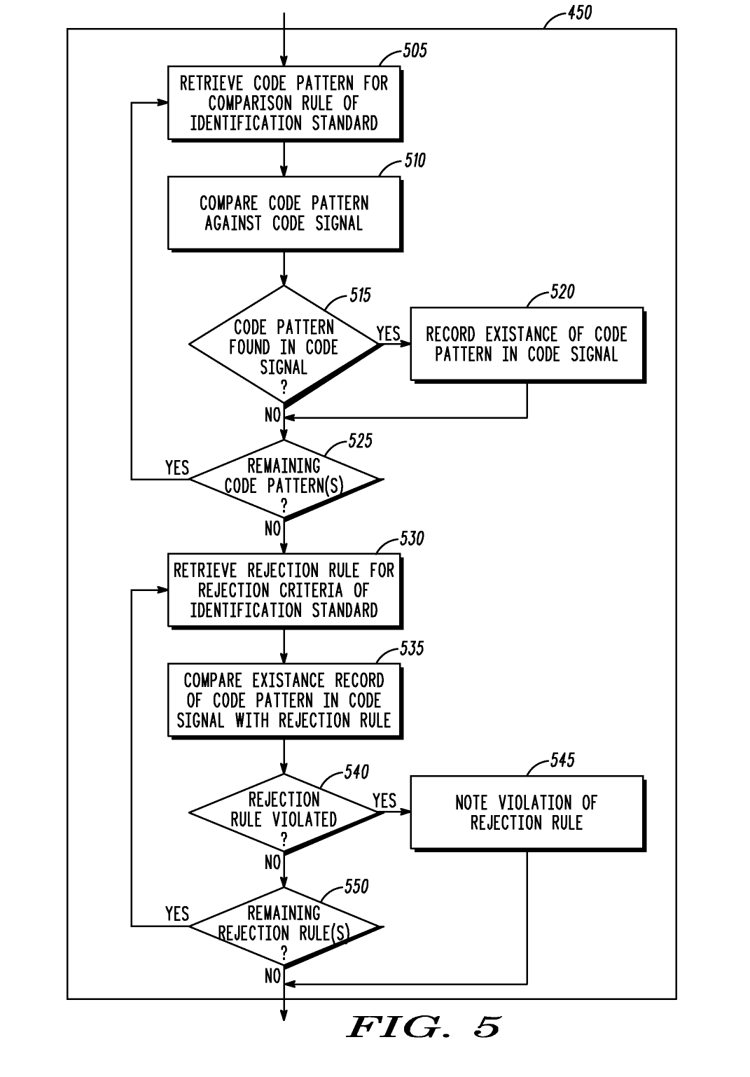

In block 450, the code signal 160 is analyzed. This analysis is performed, as will be explained in greater detail in the discussion of FIG. 5, by performing a comparison of the code signal 160 against the retrieved identification standard 240. Block 450 then transfers control to block 460.

If the rejection criteria 320 for the compared identification standard 240 is violated, block 460 transfers control to block 480. Otherwise, block 460 transfers control to block 470.

If one or more additional identification standards 240 remain to be compared against the code signal 160, block 470 transfers control back to block 440. Otherwise, block 470 transfers control back to block 410 ready to receive another code signal 160.

In block 480, notification is performed that the code signal 160 violated at least one of the rejection rules 340 for one of the rejection criteria 320. Such notification may or may not include identification of the specific code type 250 with its associated identification standard 240, the specific code pattern 330 in the comparison rule 310 of the identification standard 240, and the specific rejection rule 340 in the rejection criteria 320 of the identification standard 240. Block 480 then transfers control back to block 410 ready to receive another code signal 160.

FIG. 5 is a flow diagram of the analysis block 450 of the method 400 of FIG. 4. For implementations using the representative embodiment of FIG. 5, the data type management unit 120 would not typically interface with a memory management unit. Block 505 receives control from block 440 when block 440 transfers control to block 450 in FIG. 4. In block 505, one of the code patterns 330 of the comparison rule 310 for the retrieved code type 250 identification standard 240 is retrieved from the identification standard 240. Block 505 then transfers control to block 510.

In block 510, the retrieved code pattern 330 is compared against the code signal 160. Block 510 then transfers control to block 515.

If the retrieved code pattern 330 was found in the code signal 160, block 515 transfers control to block 520. Otherwise, block 515 transfers control to block 525.

In block 520, the existence of the code pattern 330 of the comparison rule 310 associated with the retrieved identification standard 240 in the code signal 160 is recorded. Block 520 then transfers control to block 525.

If one or more additional code patterns 330 remain to be compared against the code signal 160, block 525 transfers control back to block 505. Otherwise, block 525 transfers control to block 530.

In block 530, one of the rejection rules 340 of the rejection criteria 320 for the retrieved code type 250 identification standard 240 is retrieved from the identification standard 240. Block 530 then transfers control to block 535.

In block 535, the record of existence of the retrieved code pattern 330 in the code signal 160 is compared against the retrieved rejection rule 340. Block 535 then transfers control to block 540.

If the comparison of the retrieved code pattern 330 in the code signal 160 against the retrieved rejection rule 340 indicates a rejection rule 340 violation, block 540 transfers control to block 545. Otherwise, block 540 transfers control to block 550.

In block 545, the violation of the rejection rule 340 is noted. Block 545 then transfers control to block 450 in FIG. 4 which in turn transfers control to block 460.

If one or more additional rejection rules 340 remain to be compared against the record of existence of the code pattern 330 in the code signal 160, block 550 transfers control back to block 530. Otherwise, block 550 transfers control to block 450 in FIG. 4 which in turn transfers control to block 460.

As will be appreciated by one of ordinary skill in the art, various processes, such as those of FIG. 5 which are presented as a set of processes working on a single code signal 160, could in other representative embodiments be performed in parallel for other code signals 160.

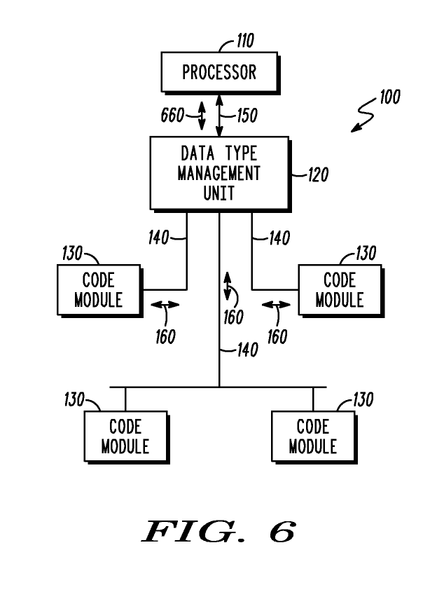

FIG. 6 is a block diagram of another data processing system 100 as described in various representative embodiments. FIG. 6 shows a data type management unit 120 in an inline interface implementation. In FIG. 6, a processor 110 receives and transmits code signals 160 between code modules 130 on code transmission channels 140 and the processor 110 on the processor transmission channel 150 and through the data type management unit 120. In the representative embodiment of FIG. 6, the data type management unit 120 monitors and in some cases controls the flow of code signals 160 to and from the code modules 130 on the code transmission channels 140 and the code signals 160 to and from the processor 110 on the processor transmission channel 150. Among other capabilities, the data type management unit 120 can be programmed to inform the processor 110 whenever the code signals 160 received from the code transmission channels 140 differs from a specified code type 250 or specified code types 250. And, in such cases the data type management unit 120 can also be programmed to prevent the flow of code signals 160 from the data type management unit 120 to the processor 110. Further, the data type management unit 120 can be programmed to inform the processor 110 whenever the code signals 160 received from the processor transmission channel 150 differs from a specified code type 250 or specified code types 250. And, in such cases the data type management unit 120 can also be programmed to prevent the flow of code signals 160 from the data type management unit 120 to the intended code module(s) 130. Signals between the processor 110 and the data type management unit 120 are shown in FIG. 6 as internal signals 660 and include the code signals 160 whether stripped of code sequences that encapsulate the coded information in the code signal 160 or not and any other information and control signals flowing between the processor 110 and the data type management unit 120.

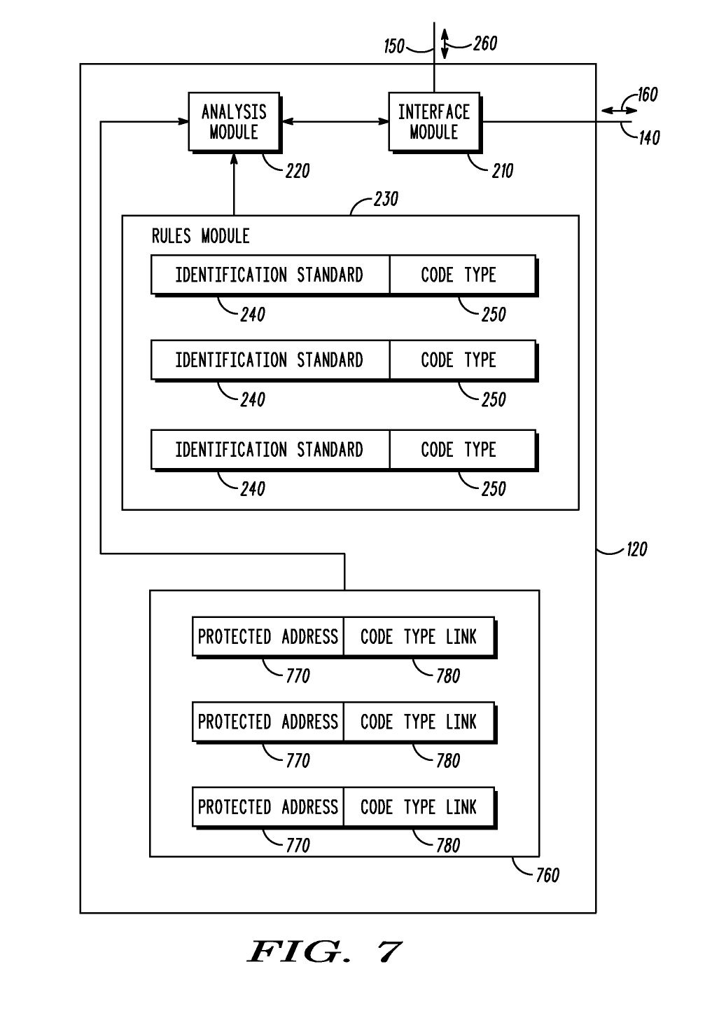

FIG. 7 is a block diagram of another data type management unit 120 of FIG. 1 and of FIG. 6. For implementations of the representative embodiment of FIG. 7, the data type management unit 120 could be interfaced with a memory management unit. In FIG. 7, the data type management unit 120 comprises the interface module 210, the analysis module 220, the rules module 230 and an address module 760. The rules module 230 comprises the identification standard 240 associated with a code type 250 for each code type 250 that the data type management unit 120 needs to be able to recognize. A representative embodiment of the identification standard 240 is shown in FIG. 3 and discussed therewith. The address module 760 comprises at least one protected address 770 paired with a code type link 780. Each code type link 780 links its paired protected address 770 with one of the identification standards 240. If, as described above, the code signal 160 violates the rejection criteria 320 of the linked identification standard 240 for the associated code type 250, the code signal 160 will be prevented from being transmitted to the associated protected address 770.

FIG. 1 and FIG. 6 show the first transmission channel 140 as coupling the data type management unit 120 to code modules 130 and second transmission channel 150 coupling the data type management unit 120 to the control module 110. However, both the first transmission channel 140 and the second transmission channel 150 could couple the data type management unit 120 to more generally configured external modules 110,130 either of which could be a code module 130, a control module 110, a processor 110, a central processing unit 110, or other appropriately configured modules, as for example a computer memory. The first transmission channel 140 and the second transmission channel 150 could be computer buses, data channels, or the like.

In a first operating mode, which is referred to herein as a receiving mode, the interface module 210 receives one or more code signals 160 on at least one code transmission channel 140 from at least one code module 130. The interface module 210 appropriately modifies the received code signals 160 which may include stripping various code sequences that encapsulate the coded information in the code signal 160. The modified code signal 160 is then transferred to the analysis module 220. The analysis module 220 retrieves identification standards 240 and the code type 250 associated with each identification standard 240 from the rules module 230. Each identification standard 240 retrieved comprises a comparison rule 310 and a rejection criteria 320, and each comparison rule 310 comprises at least one code pattern 330 representative of the associated code type 250. Each of the rejection criteria 320 comprises one or more rejection rules 340 of which each, if violated, is the basis for preventing the modified code signal 160 from being transmitted to the protected address 770 of the address module 760 linked to the identification standard 240. For each code signal 160 transferred to the analysis module 220, the analysis module 220 separately compares each identification standard 240 using its associated code patterns 330 against the transferred code signal 160 and evaluates the results of each comparison. If the comparison violates one of the rejection rules 340 of its associated rejection criteria 320 for any one of the comparisons, the analysis module 220 notifies the control module 110 of such violation via a notification signal 260 on the processor transmission channel 150.

In a second operating mode which is referred to herein as a transmitting mode, the analysis module 220 receives an internal signal 660 from the processor 110 which is intended for transmission as code signal 160 on at least one code transmission channel 140 to at least one code module 130. The analysis module 220 retrieves identification standards 240 and the code type 250 associated with each identification standard 240 from the rules module 230. Each identification standard 240 retrieved comprises a comparison rule 310 and a rejection criteria 320, and each comparison rule 310 comprises at least one code pattern 330 representative of the associated code type 250.

Each of the rejection criteria 320 comprises one or more rejection rules 340 of which each, if violated, is the basis for preventing the modified code signal 160 from being transmitted to the protected address 770 of the address module 760 linked to the identification standard 240. For each code signal 160 transferred to the analysis module 220, the analysis module 220 separately compares each identification standard 240 using its associated code patterns 330 against the transferred code signal 160 and evaluates the results of each comparison. If the comparison violates one of the rejection rules 340 of its associated rejection criteria 320 for any one of the comparisons, the analysis module 220 notifies the control module 110 of such violation via a notification signal 260 on the processor transmission channel 150.

If a violation of the rejection criteria 320 does not occur, the modified code signal 160 is transferred from the analysis module 220 to the interface module 210. The interface module 210 appropriately modifies the received internal code signal 660 intended for transmission as code signal 160 which may include adding various code sequences that encapsulate the coded information in the code signal 160. Otherwise, the analysis module 220 blocks transmission of the code signal 160. The analysis module 220 can then notify the control module 110 of such violation via a notification signal 260 on the processor transmission channel 150.

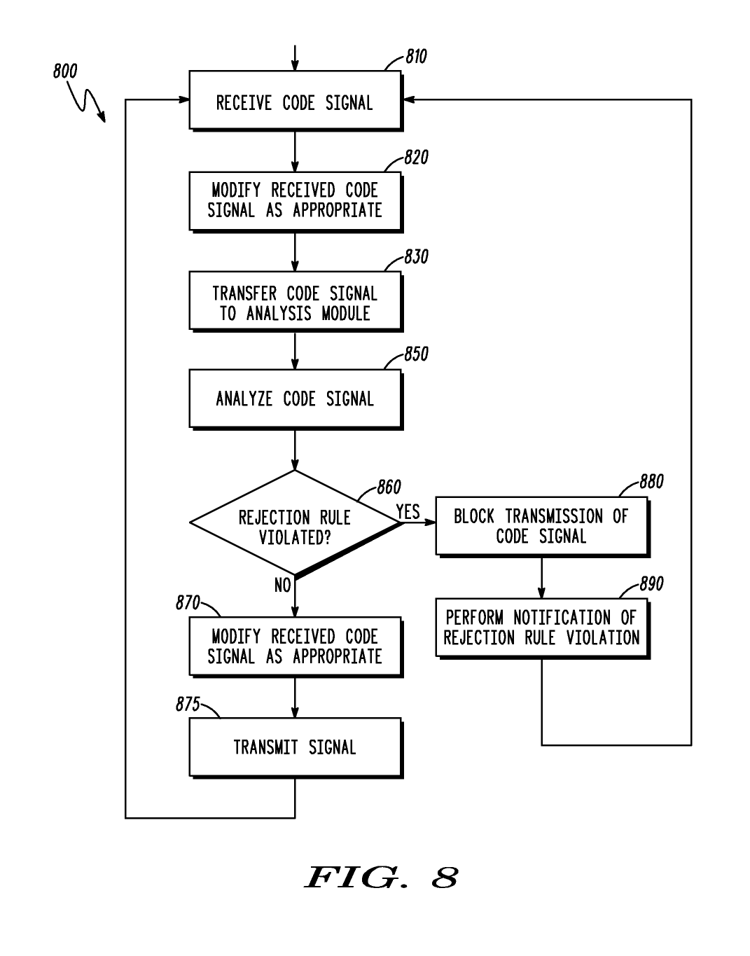

FIG. 8 is a flow diagram of another method 800 for determining whether or not a rejection criteria 320 is violated for a received code signal 160 as described in various representative embodiments. FIG. 8 is applicable to the use of a data type management unit 120 in an inline interface implementation. In block 810, a code signal 160 is received by the interface module 210 of the data type management unit 120. Block 810 then transfers control to block 820.

In optional block 820, the interface module 210 appropriately modifies the received code signal 160 which may include stripping and/or adding various code sequences that encapsulate the coded information in the code signal 160. Block 820 then transfers control to block 830.

In block 830, the modified code signal 160 may then optionally be transferred to the analysis module 220 or may remain in its current memory location for subsequent analysis by the analysis module 220. Block 830 then transfers control to block 850.

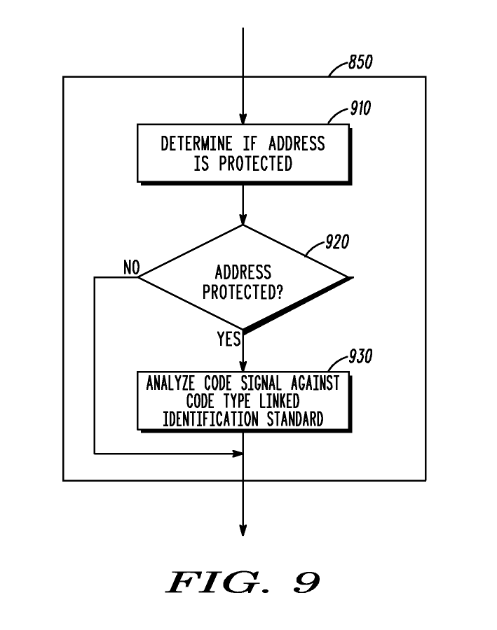

In block 850, the code signal 160 is analyzed. This analysis is performed, as will be explained in greater detail in the discussion of FIGS. 9-11, by first determining whether or not the destination address for the code signal 160 is one of the protected addresses 770 in the address module 760 of FIG. 7 and then, if the destination address is one of the protected addresses 770, performing a comparison of the code signal 160 against the retrieved identification standard 240. Block 850 then transfers control to block 860.

If the rejection criteria 320 for the compared identification standard 240 is violated, block 860 transfers control to block 880. Otherwise, block 860 transfers control to block 870.

In optional block 870, the interface module 210 appropriately modifies the received code signal 160 which may include stripping and/or adding various code sequences that encapsulate the coded information in the code signal 160. Block 870 then transfers control to block 875.

In block 875, the code signal 160 is transmitted to one or more code modules 130 on one or more code transmission channels 140. In an alternative embodiment, prior to transmission, the code signal 160 may be encapsulated with various code sequences as appropriate for transmission. Block 875 then transfers control back to block 810 ready to receive another code signal 160.

In block 880, transmission of the code signal 160 is blocked. Block 880 then transfers control to block 890.

In block 890, notification is performed that the code signal 160 violated at least one of the rejection rules 340 for one of the rejection criteria 320. Such notification may or may not include identification of the specific code type 250 with its associated identification standard 240, the specific code pattern 330 in the comparison rule 310 of the identification standard 240, and the specific rejection rule 340 in the rejection criteria 320 of the identification standard 240. Block 890 then transfers control back to block 810 ready to receive another code signal 160.

In an alternative embodiment, block 830 of FIG. 8 transfers control to the initial block (block 505 in FIG. 5) of the analysis block 450 of FIG. 4 instead of to the analysis block 850 of FIG. 8. The analysis block 450 of FIG. 4 is shown in more detail in FIG. 5, and the analysis block 850 of FIG. 8 is shown in more detail in FIGS. 9-11. In this embodiment, the terminating blocks (blocks 545 and 550 in FIG. 5) of the analysis block 450 transfer control, as appropriate, back to block 860 of FIG. 8. This alternative embodiment is applicable to use of a data type management unit 120 in an inline interface implementation without interface with a memory management unit.

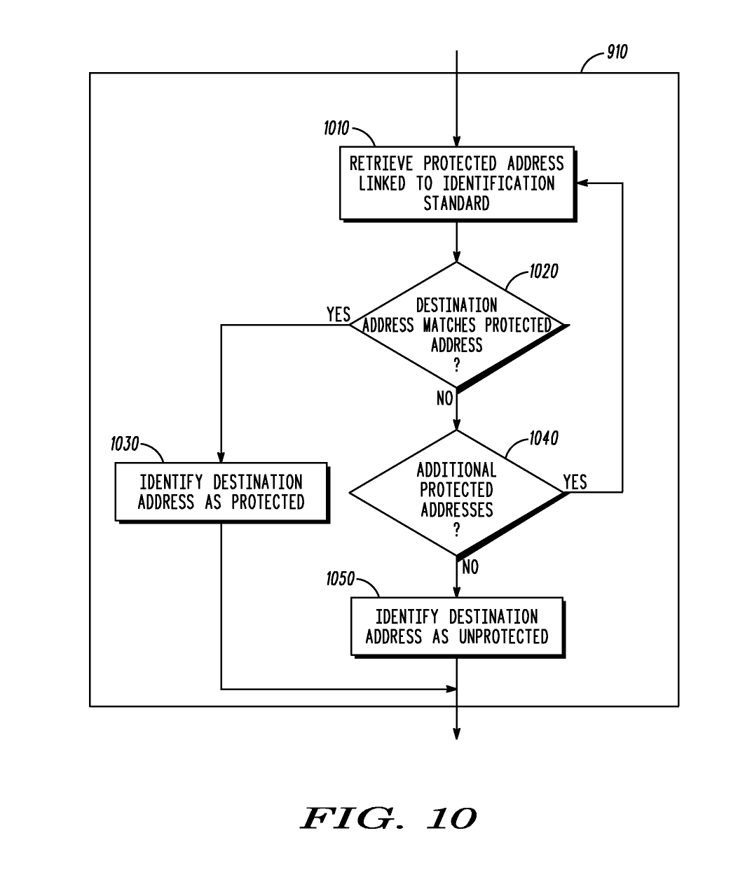

FIG. 9 is a flow diagram of the analysis performed in block 850 of the method 800 of FIG. 8. FIG. 9 is applicable to the use of a data type management unit 120 in a monitor interface implementation or an inline interface implementation. For implementations using the representative embodiment of FIG. 9, the data type management unit 120 could interface with a memory management unit. Block 910 receives control from block 850 when block 830 transfers control to block 850. In block 910, a determination is made as to whether or not the destination address is one of the protected addresses 770 in the address module 760. The details of this determination are explained in greater detail in the discussion of FIG. 10. Block 910 then transfers control to block 920.

If the destination address is one of the protected addresses 770 in the address module 760, block 920 transfers control to block 930. Otherwise, block 920 transfers control back to block 850 in FIG. 8 which in turn transfers control to block 860.

In block 930, the code signal 930 is analyzed against the identification standard 240 to which the protected address 770 that matches the destination address of the code signal 160 is linked via the code type link 780.

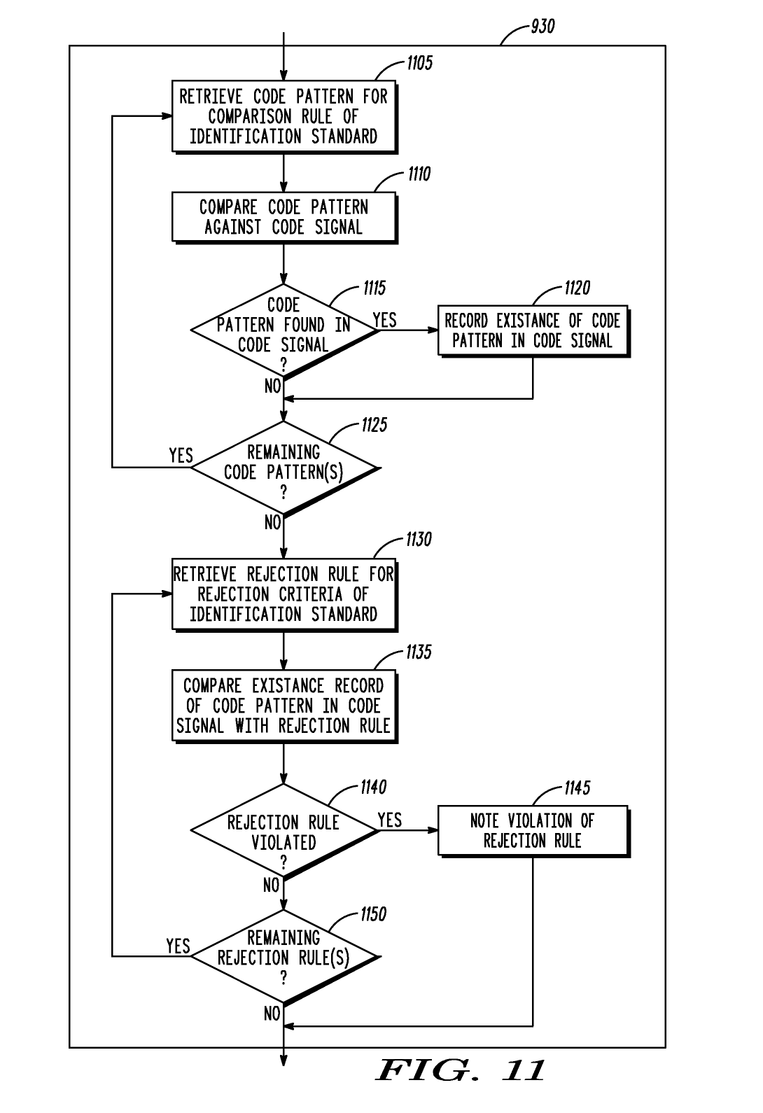

This analysis is performed, as will be explained in greater detail in the discussion of FIG. 11, by performing a comparison of the code signal 160 against the retrieved identification standard 240. Block 930 then transfers control back to block 850 in FIG. 8 which in turn transfers control to block 860.

FIG. 10 is a flow diagram of the determination block 910 of FIG. 9. FIG. 10 is applicable to the use of a data type management unit 120 in a monitor interface implementation or an inline interface implementation. For implementations using the representative embodiment of FIG. 10, the data type management unit 120 could interface with a memory management unit. Block 1010 receives control from block 910 when block 910 receives control from block 850 of FIG. 8. In block 1010, one of the protected addresses 770 and paired code type links 780 in the address module 760 is retrieved from the address module 760 by the analysis module 220. Block 1010 then transfers control to block 1020.

If the destination address matches the retrieved protected address 770, block 1020 transfers control to block 1030. Otherwise, block 1020 transfers control to block 1040.

In block 1030, the destination address is identified as being the retrieved protected address 770. Block 1030 then transfers control back to block 910 in FIG. 9 which then transfers control to block 920 in FIG. 9.

If there are additional protected addresses 770 in the address module 760 that have not been retrieved, block 1040 transfers control back to block 1010. Otherwise, block 1040 transfers control to block 1050.

In block 1050, the destination address is identified as not one of the retrieved protected addresses 770. Block 1050 then transfers control back to block 910 in FIG. 9 which then transfers control to block 920 in FIG. 9.

FIG. 11 is a flow diagram of the analysis block 930 of FIG. 9. FIG. 11 is applicable to the use of a data type management unit 120 in a monitor interface implementation or an inline interface implementation. For implementations using the representative embodiment of FIG. 11, the data type management unit 120 could interface with a memory management unit. Block 1105 receives control from block 930 when block 920 transfers control to block 930 in FIG. 9. In block 1105, one of the code patterns 330 of the comparison rule 310 for the retrieved code type 250 identification standard 240 is retrieved from the identification standard 240. Block 1105 then transfers control to block 1110.

In block 1110, the retrieved code pattern 330 is compared against the code signal 160. Block 1110 then transfers control to block 1115.

If the retrieved code pattern 330 was found in the code signal 160, block 1115 transfers control to block 1120. Otherwise, block 1115 transfers control to block 1125.

In block 1120, the existence of the code pattern 330 of the comparison rule 310 associated with the retrieved identification standard 240 in the code signal 160 is recorded. Block 1120 then transfers control to block 1125.

If one or more additional code patterns 330 remain to be compared against the code signal 160, block 1125 transfers control back to block 1105. Otherwise, block 1125 transfers control to block 1130.

In block 1130, one of the rejection rules 340 of the rejection criteria 320 for the retrieved code type 250 identification standard 240 is retrieved from the identification standard 240. Block 1130 then transfers control to block 1135.

In block 1135, the record of existence of the retrieved code pattern 330 in the code signal 160 is compared against the retrieved rejection rule 340. Block 1135 then transfers control to block 1140.

If the comparison of the retrieved code pattern 330 in the code signal 160 against the retrieved rejection rule 340 indicates a rejection rule 340 violation, block 1140 transfers control to block 1145. Otherwise, block 1140 transfers control to block 1150.

In block 1145, the violation of the rejection rule 340 is noted. Block 1145 then transfers control to block 930 in FIG. 9 which transfers control to block 850 in FIG. 8 which in turn transfers control to block 860 in FIG. 8.

If one or more additional rejection rules 340 remain to be compared against the record of existence of the code pattern 330 in the code signal 160, block 1150 transfers control back to block 1130. Otherwise, block 1130 transfers control to block 930 in FIG. 9 which transfers control to block 850 in FIG. 8 which in turn transfers control to block 860 in FIG. 8.

As will be appreciated by one of ordinary skill in the art, various processes, such as those of FIG. 11 which are presented as a set of processes working on a single code signal 160, could in other representative embodiments be performed in parallel for other code signals 160.

In representative embodiments, a data type management unit 120 comprises a rules module 230 configured to comprise at least one identification standard 240 paired with an associated code type 250, an interface module 210 configured to receive a code signal 160, and an analysis module 220 coupled to the interface module 210 and to the rules module 230, configured to compare the received code signal 160 to each code pattern 330 in each identification standard 240, and configured to recognize if one or more of the comparison results violates one or more of the rejection rules 340. Each identification standard 240 comprises a comparison rule 310 paired with an associated rejection criteria 320; the comparison rule 310 of each identification standard 240 comprises at least one code pattern 330 representative of the associated code type 250; and the rejection criteria 320 of each identification standard 240 comprises at least one rejection rule 340.

In other representative embodiments, a method 400,800 comprises receiving a code signal 160, retrieving an identification standard 240 and its paired code type 250 from a rules module 230, comparing the received code signal 160 to each code pattern 330 in each identification standard 240, and recognizing if one or more of the comparison results violates one or more of the rejection rules 340. The rules module 230 comprises at least one identification standard 240 paired with an associated code type 250; each identification standard 240 comprises a comparison rule 310 paired with an associated rejection criteria 320; the comparison rule 310 of each identification standard 240 comprises at least one code pattern 330 representative of the associated code type 250; and the rejection criteria 320 of each identification standard 240 comprises at least one rejection rule 340.

Table 1 provides a convenient cross reference for identifying appropriate figures which may be referred to depending upon the conditions of use. In particular, for the monitor mode it is convenient to refer to FIG. 1 for a block diagram of the data processing system 100 and for the inline mode it is convenient to refer to FIG. 6. And as a further example, for those implementations in which the data type management unit 120 is in monitor mode and does not interface with a memory management unit or other similar unit, the reference should be made to FIG. 2 and to FIG. 3 for appropriate data structures and to FIGS. 4 and 5 for appropriate flow charts.

TABLE 1

| | Block Diagram of | Memory | Data Type | |
|---|---|---|---|---|
| | Data Processing | Management | Management Unit | Method Flow |
| Mode | System | Unit Interfaced? | Data Structures | Charts |
| Monitor | FIG. 1 | NO | FIG. 2 | FIG. 4 & |
| Mode | | | FIG. 3 | FIG. 5 |
| | | | | (Block 450 is the |
| | | | | Analysis Block) |
| | | YES | FIG. 7 | FIG. 4 & |
| | | | FIG. 3 | FIGS. 9–11 |
| | | | | (Block 850 is the |
| | | | | Analysis Block) |
| Inline | FIG. 6 | NO | FIG. 2 & | FIG. 8 & |
| Mode | | | FIG. 3 | FIG. 5 |
| | | | | (Block 450 is |
| | | | | the Analysis Block) |
| | | YES | FIG. 7 & | FIG. 8 & |
| | | | FIG. 3 | FIGS. 9–11 |
| | | | | (Block 850 is the |
| | | | | Analysis Block) |

As is the case, in many data-processing products, the systems, units, modules, and functions described above may be implemented as a combination of hardware and software components including, but not limited to, processors, memories, state machine logic, and bus interface circuits. Moreover, the functionality required for use of the representative embodiments may be embodied in computer-readable media (such as floppy disks, conventional hard disks, DVDs, CD-ROMs, Flash ROMs, nonvolatile ROM, and RAM) to be used in programming an information-processing apparatus (e.g., the data type management unit 120 shown in the various figures) to perform in accordance with the techniques so described.

The term “program storage medium” is broadly defined herein to include any kind of computer memory such as, but not limited to, floppy disks, conventional hard disks, DVDs, CD-ROMs, Flash ROMs, nonvolatile ROM, and RAM.

In representative embodiments, data type management units are disclosed herein which can be programmed to prevent intrusions or attacks from clandestine sources. Data type management units and methods are disclosed for preventing attackers from sending code through data interfaces. The data type management unit can be programmed to prevent transmission of signals that do not meet certain criteria through a data interface and optionally to provide notification of such an attempt. Alternatively, the data type management unit can be programmed to monitor, but not prevent, the transmission of signals that do not meet certain criteria through the data interface and to provide notification of such transmissions.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A data type management unit, comprising:
a rules module configured to comprise at least one identification standard paired with an associated code type, wherein each identification standard comprises a comparison rule paired with an associated rejection criteria, wherein the comparison rule of each identification standard comprises at least one code pattern representative of the associated code type, and wherein the rejection criteria of each identification standard comprises at least one rejection rule;
an interface module configured to receive a code signal; and
an analysis module coupled to the interface module and to the rules module, configured to compare the received code signal to each code pattern in each identification standard, and configured to recognize if one or more of the comparison results violates one or more of the rejection rules.

2. The data type management unit as recited in claim 1, wherein the interface module is coupled to an external module and wherein, if one of the comparisons violates one of the associated rejection rules, the analysis module is configured to report the violation to the external module via the interface module.

3. The data type management unit as recited in claim 2, wherein the external module is a control module.

4. The data type management unit as recited in claim 1, wherein the interface module is coupled to an external module and wherein the analysis module is configured to report the code type resulting in the violation to the external module via the interface module.

5. The data type management unit as recited in claim 1, wherein at least one code type of at least one identification standard is selected from the group consisting of text and binary code.

6. The data type management unit as recited in claim 1,
wherein, if the comparison results do not violate any of the rejection rules:
the interface module is configured to transmit the received code signal to an external module,
otherwise:
the interface module is configured to prevent transmission of the code signal to the external module.

7. The data type management unit as recited in claim 6, wherein the external module is a control module.

8. The data type management unit as recited in claim 6, wherein the external module is a central processing unit.

9. The data type management unit as recited in claim 1, further comprising:
an address module coupled to the analysis module, wherein the address module comprises at least one protected address paired with an associated code type link, wherein each code type link identifies at least one paired code type and identification standard of the rules module, and wherein, if one comparison result violates one rejection rule of one identification standard identified by one code type link, the data type management unit is configured to block transmission of the code signal to the protected address paired with that code type link.

10. The data type management unit as recited in claim 1, further comprising:
an address module coupled to the analysis module, wherein the interface module is coupled to an external module, wherein the address module comprises at least one protected address paired with an associated code type link, wherein each code type link identifies at least one paired code type and identification standard of the rules module, and wherein, if one comparison result violates one rejection rule of one identification standard identified by one code type link, the analysis module is configured to report the violation to the external module via the interface module.

11. The data type management unit as recited in claim 10, wherein the external module is a control module.

12. The data type management unit as recited in claim 10, wherein the external module is a central processing unit.

13. A method, comprising:
receiving a code signal;
retrieving an identification standard and its paired code type from a rules module, wherein the rules module comprises at least one identification standard paired with its associated code type, wherein each identification standard comprises a comparison rule paired with an associated rejection criteria, wherein the comparison rule of each identification standard comprises at least one code pattern representative of the associated code type, and wherein the rejection criteria of each identification standard comprises at least one rejection rule;
comparing the received code signal to each code pattern in each identification standard; and
recognizing if one or more of the comparison results violates one or more of the rejection rules.

14. The method as recited in claim 13, further comprising:
reporting the code type resulting in the violation to an external module.

15. The method as recited in claim 13, wherein at least one code type of at least one identification standard is selected from the group consisting of text and binary code.

16. The method as recited in claim 13,
wherein, if the comparison results do not violate any of the rejection rules:
transmitting the received code signal to an external module,
otherwise:
preventing transmission of the code signal to the external module.

17. The method as recited in claim 16, wherein the external module is a control unit.

18. The method as recited in claim 17, further comprising:
accessing an address module, wherein the address module comprises at least one protected address paired with an associated code type link, wherein each code type link identifies at least one paired code type and identification standard of the rules module, and wherein, if one comparison result violates one rejection rule of one identification standard identified by one code type link, blocking transmission of the code signal to the protected address paired with that code type link.

19. The method as recited in claim 13, further comprising:
accessing an address module, wherein an interface module is coupled to a control module, wherein the address module comprises at least one protected address paired with an associated code type link, wherein each code type link identifies at least one paired code type and identification standard of the rules module, and wherein, if one comparison result violates one rejection rule of one identification standard identified by one code type link, reporting the violation to an external module.

20. The method as recited in claim 19, wherein the external module is a control module.
